(19) United States
(12) Patent Application Publication
(10) Pub. No.: US 2006/0198139 A1
(43) Pub. Date: Sep. 7, 2006

(54) LIGHT SOURCE DEVICE FOR PROJECTOR

(76) Inventor: CHUAN-TE CHENG, Miao-Li County (TW)

Correspondence Address: NORTH AMERICA INTELLECTUAL PROPERTY CORPORATION, P.O. BOX 506, MERRIFIELD, VA, 22116, US

(21) Appl. No.: 11/307,684

(22) Filed: Feb. 17, 2006

(30) Foreign Application Priority Data
Mar. 7, 2005 (TW) 094106883

(51) Int. Cl. F21V 7/00

(52) U.S. Cl. 362/241; 362/298; 362/346

(57) ABSTRACT

A light source device for a projector comprises a plurality of light source structures and a reflecting element, in which each light source structure comprises a first reflector that the inner surface thereof is a semi-elliptical surface, a reflecting portion and a burner. The burner is installed on a focus of the semi-elliptical surface, the reflecting element is disposed on a beam outputting route of at least one of the light source structures. The dispositions of reflecting portion and the semi-elliptical surface are used for allowing each light source structure to provide a semi-conical beam output, and the reflecting element combines the semi-conical beams to a conical beam. Whereby, incident angle distributions of the conical beam the same as single light source can be attained and the illumination brightness can be enhanced.

### BACKGROUND OF THE INVENTION

1. Field of the Invention

The present invention relates to a projector, and more particularly to a light source device for a projector.

2. Description of Related Art

A light source device with a single lamp is mostly adopted in a conventional projector. However, for a large-sized meeting place such as a big conference hall, the projector projects images on a screen with a larger area at a longer distance, a beam emitted from the light source device needs a higher brightness so as to allow audiences in the whole hall to see the images on the screen clearly. If the light source device is adopted to provide the high brightness, the power is upgraded. It leads to problems such as high temperature and difficult cooling. Therefore, how to improve the problem caused from the high temperature of the light source device under a premise that the high brightness is provided is the problem of the light source device need be improved.

A light source device with multiple lamps is adopted to increase brightness. Please refer to FIG. 1. A conventional light source 10 comprises lamps 111a and 111b, a triangle pole 12 with reflecting surfaces and an integrated rod 13. The lamps 111a and 111b respectively have a elliptical reflector, beams of the lamps 111a and 111b are respectively focused after being reflected by the elliptical reflectors. When the beams emitted from the lamps 111 a and 111 b reaches reflecting surfaces of the triangle pole 12, the beams are reflected to focus on an incidence surface of the integrated rod 13. But, two lamps provide respectively two conical beams to be respectively incident at an upper side and a lower side of the integrated rod, and angles of light cones are increased. Besides, a center of the beam of the each lamp is not positioned at a center of the integrated rod. This causes the brightness at the center of a screen to be darker so that an uneven brightness condition is yielded. Furthermore, the more the angle of the light cone increases, the more the cross section of the incidence surface of the integrated rod must be reduced, and the integrated rod can then have better light transmission efficiency, but the efficiency of light coupling is lowered relatively.

Therefore, the problems such as the uneven brightness and the bad light transmission efficiency of the integrated rod still exist in the conventional light source device.

### SUMMARY OF THE INVENTION

One object of the present invention is to provide a light source device of a projector, using dispositions of a reflection portion and a semi-elliptical surface to cause each light source structure to output a semi-conical shape beam, and then using reflecting elements to compose a plurality of semi-conical beams to a conical beam so as to attain to a angle distribution of the conical beam the same as a single light source and the illumination brightness can be increased.

For attaining to the object mentioned above, a light source of a projector according to the present invention comprises a plurality of light source structures and reflecting elements, in which each light source structure comprises a reflector, a reflecting portion and a burner. The burner is disposed on a focus of the semi-elliptical surface. The reflecting element is disposed on an output route of a beam of at least one light source structure. Dispositions of the reflecting portion and the semi-elliptical surface are used for allowing each light source structure to provide a semi-conical beam output, then the reflecting element is used for composing a plurality of semi-conical beams to a conical beam so as to attain to the distribution of the angle of incidence the same as a single light source, and the illumination brightness can be increased.

### BRIEF DESCRIPTION OF THE DRAWINGS

The present invention can be more fully understood by reference to the following description and accompanying drawings, in which:

FIG. 1 is a schematic view showing a conventional light source device;

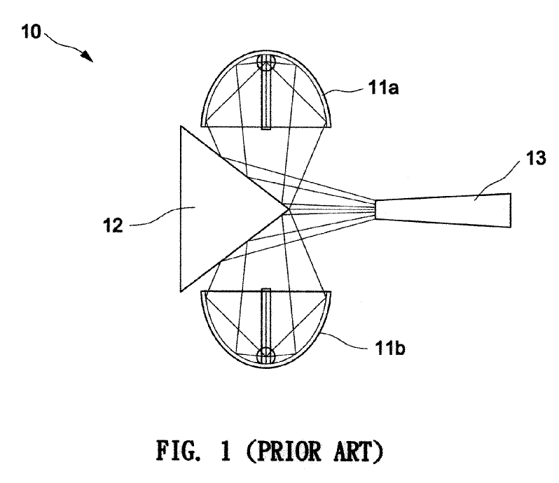

FIG. 2 is a schematic view showing a light source device of a first preferred embodiment according to the present invention;

FIG. 3 is a schematic view showing a light source device of a second preferred embodiment according to the present invention;

FIG. 4 is a schematic view showing a light source device of a third preferred embodiment according to the present invention;

FIG. 5 is a schematic view showing a light source device of a fourth preferred embodiment according to the present invention;

FIG. 6 is a schematic view showing a light source device of a fifth preferred embodiment according to the present invention;

FIG. 7 is a schematic view, showing a light source device of a sixth preferred embodiment according to the present invention;

### DETAILED DESCRIPTION OF THE PREFERRED EMBODIMENTS

### First Preferred Embodiment

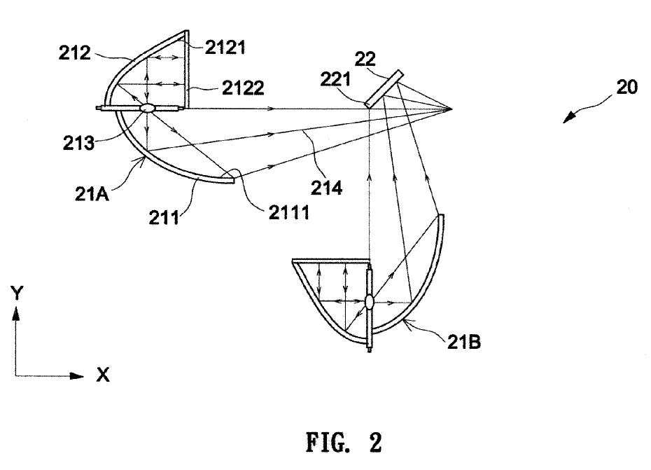

Please refer to FIG. 2. A light source device 20 comprises a plurality of light source structures and a reflecting element 22. In the embodiment, the light source device 20 comprises two light source structures 21A and 21B, the light source structures 21A and 21B are the same as each other, and optical axes of the light source structures 21A and 21B are perpendicular to each other. Taking the light source 21 as an example, it comprises a first reflector 211, a second reflector 212 and a burner 213, in which an inner surface of the first reflector 211 is a semi-elliptical surface 2111, the second reflector 212 is connected to the burner 213 and disposed at one side of the burner 213 different from the side that the first reflector 211 is disposed, and an inner surface of the second reflector 212 is a semi-parabolic surface 2121 and a focus of semi-parabolic surface 2121 is disposed at the same position as a focus of the elliptical surface 2111, a reflecting portion 2122 perpendicular to a direction of the burner 213 is disposed at a front end of the second reflector 212 so as to shield the front end surface of the second reflector 212. A reflecting layer facing to a surface of the semi-parabolic surface 2121 is disposed on the reflecting portion 2122 so as to allow a beam reflected from the semi-parabolic surface 2121 to be reflected back to the first reflector 211 and then output after being reflected by the first reflector 211. The burner 213 is disposed in the first reflector 211 and the second reflector 212 and also disposed at a common focus of the semi-elliptical surface 2111 and the semi-parabolic surface 2121, and the burner 213 is used for providing a beam. A part of the beam emitted from the burner 213 is reflected by the semi-elliptical surface 2111 to generate a semi-conical beam output. The other part of the beam emitted from the burner 213 is repeatedly reflected by the semi-parabolic surface 2121 and the reflecting portion 2122, and then reflected by the semi-elliptical surface 2111 to generate the semi-conical beam output. The front end surface of the second reflector 212 is shielded by the reflecting portion 2122, the beam generated from the light source structure 21A is enabled to attain to output as a semi-conical type from the front end surface of the first reflector 211.

The reflecting element 22 is installed on a route which a beam of the light source structure 21B is output. The reflecting element 22 is inclined with 45 degrees, and the bottom end 221 of the reflecting element 22 is disposed at an intersection of the axial line (i.e. X axis) of the burner 213 of the light source structure 21A and the axial line (i.e. Y axis) of the burner of the light source structure 21B to bend the beam output from the light source structure 21B to a beam outputting direction of the light source structure 21A so as to composed the semi-conical beams 214 respectively provided by the light source structure 21A and 21B to a conical beam.

The dispositions of the reflecting portion 2122 and the semi-elliptical surface 2111 according to the present invention converts an incident beam of a single light source structure to a semi-conical beam, and the reflecting element 22 inclined with 45 degrees is then used to compose the semi-conical beams of the light source structures 21A and 21B to the conical beam so as to attain to an incident angle distribution of the conical beam the same as the light source device with a single lamp and the brightness reaches 1.6 to 1.8 times of the light source device with a single lamp after the beams are composed.

The incident angle of the conical beam is still maintained as the incident angle of the single light source device with a single lamp, a design of a single light source structure can still be adopted on an incident surface of the integrated rod so that a light coupling efficiency and a light transmission efficiency are not influenced. The center of the conical beam is still positioned at the center of the integrated rod 13 so that the problem that the brightness at the center of the conventional double conical beams is uneven can be solved.

### Second Preferred Embodiment

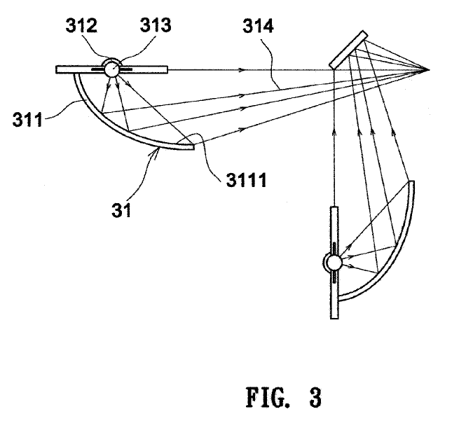

Please refer to FIG. 3. A reflecting layer 312 disposed on a surface of a burner 313 is used for replacing the second reflector 212 and the reflecting portion 2122 so as to shrink a volume of the light source device. A light source structure 31 adopted in the present invention comprises a first reflector 311 and a burner 313, an inner surface of the first reflector 311 is a semi-elliptical surface 3111. The burner 313 is installed on a focus of the semi-elliptical surface 3111 and used for providing a beam. The reflecting layer 312 is directly installed on the circumference of the side of the burner 313 opposite to the side that the semi-elliptical surface 3111 is located so as to allow the beam provided by the burner 313 covered with the reflecting layer 312 to be reflected downward to the semi-elliptical surface 3111 by the reflecting layer 312, and then an output of a semi-conical beam 314 is generated after being reflected by the semi-elliptical surface 311 1.

### Third Preferred Embodiment

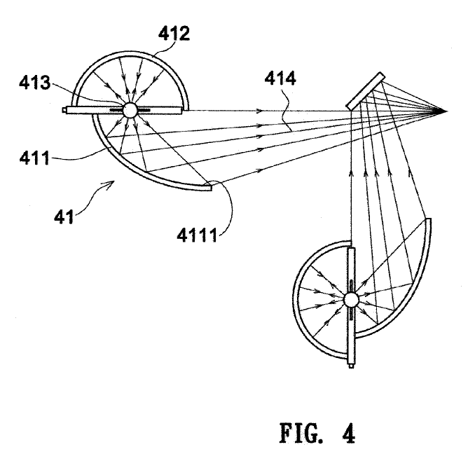

Please refer to FIG. 4. The second reflector 212 and the reflecting portion 2122 in the first preferred embodiment are replaced with a hemispherical reflecting mirror 412 in the present embodiment. A light source structure 41 comprises a first reflector 411, the hemispherical reflecting mirror 412 and a burner 413, in which an inner surface of the first reflector 411 is a semi-elliptical surface 4111. The hemispherical reflecting mirror 412 is connected to the burner 413 and positioned at one side of the burner 413 opposite to the side that the first reflector is located. The center of the hemispherical reflecting mirror 412 is positioned on a focus of the semi-elliptical surface 4111 so as to allow a beam reflected by the hemispherical reflecting mirror 412 can be further output as a semi-conical beam 414 after being reflected by the first reflector 411. The burner 413 is installed on a common focus of the semi-elliptical surface 4111 and the hemispherical reflecting mirror 412. A Part of a beam emitted from the burner 413 is directly reflected by the semi-elliptical surface 4111 and then to generate an output of a semi-conical beam, and the other parts of the beam are reflected by the hemispherical reflecting mirror 412 to semi-elliptical surface 4111 and then reflected by the semi-elliptical surface 4111 to generate an output of the semi-conical beam. The hemispherical reflecting mirror 412 is adopted to allow that the beam generated from the light source structure 41 can merely be output from a front end surface of the first reflector 411 to enable the single light source structure to be output as the semi-conical beam.

### Fourth Preferred Embodiment

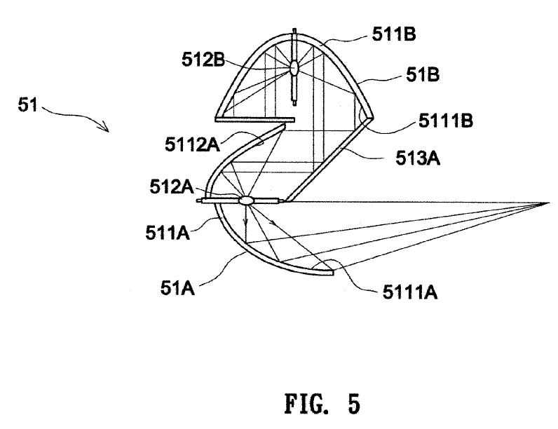

Please refer to FIG. 5. The difference between the present embodiment and the first embodiment is that a light source structure 51 is a structure with double burners and double reflectors. The light source structure 51 comprises a first light source set 51A and a second light source set 51B. The first light source 51A comprises a reflector 511A and a burner 512A, in which an inner surface of the reflector 511A is constituted by a semi-elliptical surface 5111A and a semi-parabolic surface 5112A, and a focus of the semi-elliptical surface 5111A and a focus of the semi-parabolic surface 5112A are at the same position. A reflecting portion 513A inclined with 45 degrees is disposed at a front end of the semi-parabolic surface 5112A, and a surface of the reflecting portion 513A facing to the semi-parabolic surface 5112A is disposed with a reflecting layer. The burner 512A is disposed in the reflector 511A and on a common focus of the semi-elliptical surface 5111A and the semi-parabolic surface 5112A. The burner 512A is used for providing a beam. A part of the beam emitted from the burner 512A is directly reflected by the semi-elliptical surface 5111A to generate an output of a semi-conical beam, and the other part of the beam is reflected by the semi-parabolic surface 5112A and the reflecting portion 513A into the second light source set 51B.

Furthermore, the second light source set 51B comprises a reflector 511B and a burner 512B. An inner surface of the second light source set 51B is a parabolic surface. The burner 512B is disposed on the focus of the reflector 511B, and the burner 512B is disposed perpendicular to the burner 512A of the first light source set 51A. A reflecting surface 5111B perpendicular to the burner 512B is disposed at a half opening of the reflector 511B, and the other half opening is disposed by facing to the reflecting portion 513A so as to allow the beam provided by the burner 512B to be reflected by the reflector 511B, the reflecting surface 5111B and the reflecting portion 513A to incident into the first light source set 51A.

Dispositions of the reflecting surface 5111B and the reflecting portion 513A are utilized to change an optical route of the second light source set 51B, the beam generated from the light source structure 51 is caused to be reflected only by the semi-elliptical surface 5112A of the first light source set 51A and then output as the semi-conical beam so as to attain to an effect that the single light source can maintain the beam output as the semi-conical beam. The design of the double burners is adopted in the present embodiment, and an illumination brightness of the light source structure can be enhanced.

### Fifth Preferred Embodiment

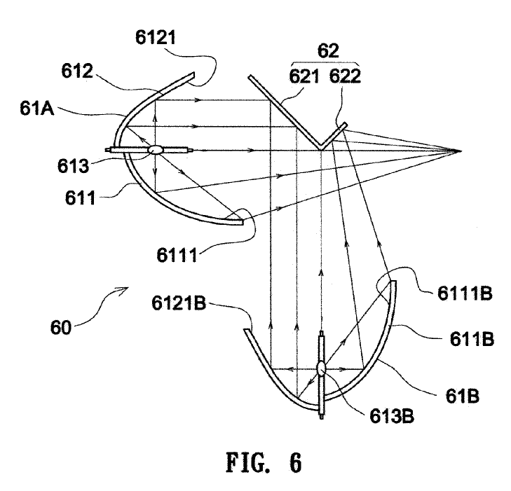

Please refer to FIG. 6. A light source device 60 comprises a plurality of light source structures and a reflecting element 62. In the present embodiment, the light source device 60 comprises two light source structures 61A and 61B, the light source structures 61A and 61B are the same as each other, and optical axes of the light source structures 61A and 61B are disposed perpendicular to each other. The light source structure 61A, for example, comprises a first reflector 611, a second reflector 612 and a burner 613, in which an inner surface of the first reflector 611 is a semi-elliptical surface 6111. The second reflector 612 is connected to the burner 613 and positioned at one side of the burner 613 opposite to the first reflector 611, and an inner surface of the second reflector 612 is a semi-parabolic surface 6121. A focus of the semi-parabolic surface 6121 and a focus of the semi-elliptical surface 6111 are at the same position. The burner 613 is used for providing a beam. The burner 613 is disposed in the first reflector 611 and the second reflector 612 and positioned on a common focus of the semi-elliptical surface 6111 and the semi-parabolic surface 6121.

Furthermore, the reflecting element 62 comprises a first reflecting portion 621 and a second reflecting portion 622, in which the first reflecting portion 621 is disposed at a front end surface of the semi-parabolic surface 6121 of the light source structure 62A, and the first reflecting portion 621 is a reflecting mirror inclined with 135 degrees to bend the beam reflected by the semi-parabolic surface 6121 into a semi-parabolic surface 6121B of the light source structure 61B. The second reflecting portion 622 is installed on the output route of the beam provided from the light source structure 61B to bend the beam output from the light source structure 61B into the beam outputting direction of the light source structure 61A through the reflection. The second reflecting portion 622 is a reflecting mirror inclined with 45 degrees, and a bottom of the second reflecting portion 622 is connected to a bottom of the first reflecting portion 621. The bottom of the second reflecting portion 622 is positioned at an intersection of an axial line of the burner 613 of the light source structure 61A and an axial line of a burner 613B of the light source structure 61B.

A Part of the beam emitted from the burner 613 of the light source structure 61A is directly reflected by the semi-elliptical surface 6111, and an output of a semi-conical beam is generated. The other part of the beam is repeatedly reflected by the semi-parabolic surface 6121 and the first reflecting portion 621 then reflected by the semi-elliptical surface 6111 of the light source structure 61A or a semi-elliptical surface 6111B of the light source structure 61B, and an output of a semi-conical beam is generated. Furthermore, a part of a beam emitted from the burner 613B of the light source structure 61B is directly reflected by the semi-elliptical surface 6111B and the second reflecting portion 622, and an output of the semi-conical beam is generated. The other part of the beam is repeatedly reflected by the semi-parabolic surface 6121B and the first reflecting portion 621 then reflected by the semi-elliptical surface 6111 of the light source structure 61A or the semi-elliptical surface 6111B of the light structure 61B and an output of the semi-conical beam is generated.

The first reflecting portion 621 is disposed at the front end surfaces of the second reflectors of the light source structures 61A and 61B to change the beam outputting routes so that the beams generated from the light source structures 61A and 61B are respectively allowed to attain to an output of the semi-conical beam from the front ends of the first reflectors 611 and 611B, and the first reflecting portion 621 inclined with 45 degrees is then utilized to compose the semi-conical beams of the light source structures 61A and 61B into a conical beam so as to attain to the incident angle distribution the same as the single light source and enhance the illumination brightness.

### Sixth Preferred Embodiment

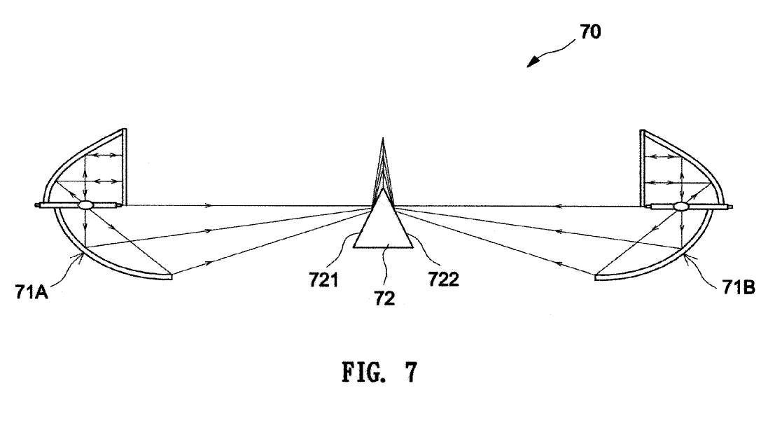

Please refer to FIG. 7. A light source device 70 comprises a plurality of light source structures and a reflecting element 72. In the embodiment, the light source device 70 comprises two light source structure 71A and 71B. The light source structure 71A and 71B are the same as the structures in the first embodiment and disposed face to face.

Furthermore, the reflecting element 72 is installed between the light source structure 71A and 71B. The reflecting element 72 is constituted by two reflecting surfaces 721 and 722 which are respectively inclined 45 degrees and connected together, and the reflecting surfaces 721 and 722 are respectively disposed by facing to semi-elliptical surfaces of the light source structures 71A and 71B so as to bend semi-conical beams respectively reflected from the semi-elliptical surfaces upward to compose to a conical beam.

The reflecting element 72 with two reflecting surfaces is utilized to compose the semi-conical beams of the light source structures 71A and 71B into the conical beam. Therefore, the incident angle distribution the same as the light source device with a single lamp can be attained and the illumination brightness can be enhanced.

Besides, a plurality of light source structures adopted in the present invention can be a combination of two the light source structures among the first, the second, the third, the fourth and the fifth embodiments to attain to the effect enhancing the illumination brightness of the light source structure.

Additional advantages and modifications readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light source device for a projector, comprising:
a plurality of light source structures, each light source structure comprises:
a first reflector, having an inner surface being a semi-elliptical surface; and
a burner, installed in said first reflector and positioned on a focus of said semi-elliptical surface, said burner being used for providing a beam, said beam being reflected by said semi-elliptical surface to output as a semi-conical beam; and
a reflecting element, disposed on a outputting route of said beam of at least one of said light source structures to compose said semi-conical beams into a conical beam.

2. The light source device according to claim 1, wherein optical axes of said light source structures are disposed perpendicular to each other.

3. The light source device according to claim 2, wherein said reflecting element is a reflecting mirror inclined with 45 degrees and disposed facing said semi-elliptical surface.

4. The light source device according to claim 2, wherein each light source structure further comprises a second reflector, an inner surface of said second reflector is a semi-parabolic surface and a focus of said second reflector is positioned on said focus of said semi-elliptical surface, and said reflecting element comprises a first reflecting portion and a second reflecting portion, said first reflecting portion is disposed at front ends of said semi-parabolic surfaces and is a reflecting mirror inclined with 135 degrees, said second reflecting portion is a reflecting mirror inclined with 45 degrees and disposed at said front end of said semi-elliptical surface of one of said light source structures.

5. The light source device according to claim 1, wherein each light source structure further comprises a second reflector and a reflecting portion, an inner surface of said second reflector is a semi-parabolic surface and a focus of said second reflector is positioned at said focus of said semi-elliptical surface, and said reflecting portion is disposed by shielding a front end surface of said second reflector so as to reflect a beam reflected by said second reflector back to said first reflector.

6. The light source device according to claim 1, wherein a reflecting layer is disposed on a circumferential surface of said burner opposite to said semi-elliptical surface and said beam provided by said burner is reflected back to said first reflector by said reflecting layer.

7. The light source device according to claim 1, wherein each of said light source structure further comprises a reflecting mirror with a hemispherical surface, said reflecting mirror is disposed at a side of said burner opposite to said first reflector, and a center of said hemispherical surface is positioned at said focus of said semi-elliptical surface.

8. The light source device according to claim 1, wherein said each light source structure further comprises a burner and a reflector with a parabolic surface, said burner is disposed in said reflector, and a beam provided by said burner is output from said semi-elliptical surface of said first reflector.

9. The light source device according to claim 1, wherein said light source structures are disposed face to face, and said reflecting element is disposed among said light source structures.

10. A light source structure, comprising:
a first reflector, having an inner surface being a semi-elliptical surface; and
a burner, disposed in said first reflector and positioned on a focus of said semi-elliptical surface, said burner being used for providing a beam, said beam being reflected by said semi-elliptical surface to output as a semi-conical beam.

11. The light source structure according to claim 10, further comprising a second reflector and a reflecting portion, an inner surface of said second reflector being a semi-parabolic surface and a focus of said second reflector being positioned at said focus of said semi-elliptical surface, and said reflecting portion being disposed by shielding a front end surface of said second reflector so as to reflect a beam reflected by said second reflector back to said first reflector.

12. The light source structure according to claim 10, wherein a reflecting layer is disposed on a circumferential surface of said burner opposite to said semi-elliptical surface, said beam provided by said burner is reflected back to said first reflector by said reflecting layer.

13. The light source structure according to claim 10, wherein said light source structure further comprises a reflecting mirror with a hemispherical surface, said reflecting mirror is disposed at one side of said burner opposite to a side facing said first reflector, and the center of said hemispherical surface is positioned at said focus of said semi-elliptical surface.

14. The light source structure according to claim 10, wherein said light source structure further comprises a burner and a reflector with a parabolic surface, said burner is disposed in said reflector, and a beam provided by said burner is output from said semi-elliptical surface of said first reflector.
